(19) United States
(12) Patent Application Publication
(10) Pub. No.: US 2013/0249301 A1
(43) Pub. Date: Sep. 26, 2013

(54) System And Method For Powering An RFID Module Using An Energy Harvesting Element

(71) Applicants: Lanny Smoot, Thousand Oaks, CA (US); John David Worrall, Clermont, FL (US); Gordon Levin, Maitland, FL (US); Scott Watson, Marina Del Rey, CA (US); Vlatko Kolaric, Suwanee, GA (US)

(72) Inventors: Lanny Smoot, Thousand Oaks, CA (US); John David Worrall, Clermont, FL (US); Gordon Levin, Maitland, FL (US); Scott Watson, Marina Del Rey, CA (US); Vlatko Kolaric, Suwanee, GA (US)

(73) Assignee: DISNEY ENTERPRISES, INC., A DELAWARE CORPORATION, Burbank, CA (US)

(21) Appl. No.: 13/425,944

(22) Filed: Mar. 21, 2012

(51) Int. Cl. H01F 38/14

(52) U.S. Cl. 307/104

(57) ABSTRACT

A system and method for powering a radio frequency identification (RFID) module includes an energy harvesting system configured to passively generate a voltage, a voltage regulator configured to regulate the passively generated voltage and a controllable port through which the passively generated voltage is provided to the RFID module.

### BACKGROUND

Radio frequency identification (RFID) technology is used in many different areas, including inventory control, point-of-sale transaction processing, determining the location of an individual, etc. An RFID element typically includes an integrated circuit and an associated antenna, the combination of which is sometimes referred to as an “RFID tag.” Some uses of RFID technology include determining the location of an individual in a particular geographical area and providing point-of-sale transactional processing for that individual. A high-frequency (HF) RFID tag is typically used at relatively short ranges, on the order of direct contact to about one foot, to support transactional interactions, such as point-of sale transactions, where an individual is charged for a product or service. Due to the nature of these transactions, they demand an affirmative action by the individual, such as swiping the RFID tag against a reader to initiate the transaction.

For RFID applications that do not demand an affirmative action by the individual, an ultra-high frequency (UHF) RFID tag can be used at relatively long ranges, on the order of 10-20 feet, to passively detect the proximity of an individual as they enter an area monitored for the presence of the UHF RFID tag. These UHF RFID tags are sometimes referred to as “far field” RFID tags. Such RFID applications can be useful for situations in which it is desirable to passively monitor for the presence of the wearer or allow the wearer to engage in an interactive experience without requiring any deliberate action by the wearer.

In some applications, one or more RFID tags can be located in a wearable item, such as a wristband, or other item, that can be worn by an individual. An example is an RFID wristband worn by a patient in a hospital or an attendee at an entertainment venue. These RFID tags typically employ HF technology and require the wearer to tap or swipe a reader to obtain the desired product or service. This “near field” tap or swipe results in a transactional type experience for the wearer, as described above.

One challenge with “far field” UHF RFID applications is that in order to avoid the need for a replaceable power source, such as a battery, the RFID circuitry generally requires a relatively large antenna to be able to provide the RFID tag with a signal having adequate signal strength. Such a large antenna does not readily lend itself to incorporation in a small, wearable item.

Therefore, it would be desirable to have a UHF RFID tag incorporated into a wearable item that does not require a replaceable power source or an inordinately large antenna.

### SUMMARY

Embodiments of a system for powering a radio frequency identification (RFID) module include an energy harvesting system configured to passively generate a voltage, a voltage regulator configured to regulate the passively generated voltage and a controllable port through which the passively generated voltage is provided to the RFID module.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a schematic diagram illustrating a high-frequency (HF)/ ultra high-frequency (UHF) RFID assembly.

FIG. 2 is a plan view illustrating the RFID module of FIG. 1.

FIG. 3A is a plan view illustrating a wristband assembly having the RFID assembly of FIG. 1.

FIG. 3B is a cross-sectional view illustrating the wristband assembly of FIG. 3A.

FIG. 4 is a cross-sectional view of a portion of the RFID module located within the wristband of FIG. 3A and FIG. 3B.

FIG. 5 is a block diagram illustrating an embodiment of the energy harvesting system of FIG. 4, and additional related circuitry.

FIG. 6A is a schematic diagram illustrating a first embodiment of the energy harvesting system of FIG. 5.

FIG. 6B is a schematic diagram illustrating an alternative embodiment of the energy harvesting system of FIG. 5.

FIG. 6C is a schematic diagram illustrating an alternative embodiment of the energy harvesting system of FIG. 5.

FIG. 7 is a schematic diagram illustrating another alternate alternative embodiment of the energy harvesting system of FIG. 5.

FIG. 8 is a schematic diagram illustrating another alternative embodiment of the energy harvesting system of FIG. 5.

FIG. 9 is a schematic diagram illustrating an example of using low frequency RF energy to create magnetic inductive coupling to supply the energy harvesting element.

FIG. 10 is a view illustrating an application of the RFID assembly of FIG. 1.

FIG. 11 is a flowchart describing an exemplary method for powering an RFID module using an energy harvesting element.

### DETAILED DESCRIPTION

The system and method for powering an RFID module using an energy harvesting element can be used to increase the sensitivity of ultra-high frequency (UHF) circuitry in an RFID module having high-frequency (HF) and UHF circuitry. Shorter range HF RFID circuitry can be used to process a transaction that requires an affirmative action by a user, such as a swipe or other direct contact between the RFID tag and a reader. Such transactions typically involve a service or product for which there is a charge or fee and for which the individual must agree to pay. When used in an entertainment venue such as an amusement facility, longer range UHF RFID circuitry can be used to passively determine an individual's proximity in a geographical area. Applications of this nature could include interactive and personalized entertainment experiences, as well as capturing various operational metrics such as person counts and flow estimation, and possibly security or other location/behavior tracking applications. However, without a power source to provide external power to the UHF circuitry, the sensitivity, and therefore, the useful range, of the UHF RFID circuitry is limited.

Several challenges arise when combining and powering both UHF and HF circuitry in a single RFID module. There is limited space in a wristband or other wearable format to combine the two RF technologies. The performance and read range of a UHF antenna is reduced when located in close proximity to human skin, often necessitating providing increased power to the UHF circuitry to improve the sensitivity of the UHF antenna and related circuitry. As used herein, the term “RFID” encompasses all known RFID technologies including, for example, high-frequency (HF), ultra-high frequency (UHF), low-frequency (LF), active, passive and semi-passive, operating in frequencies ranging from approximately 800 MHz to approximately 5.8 GHz.

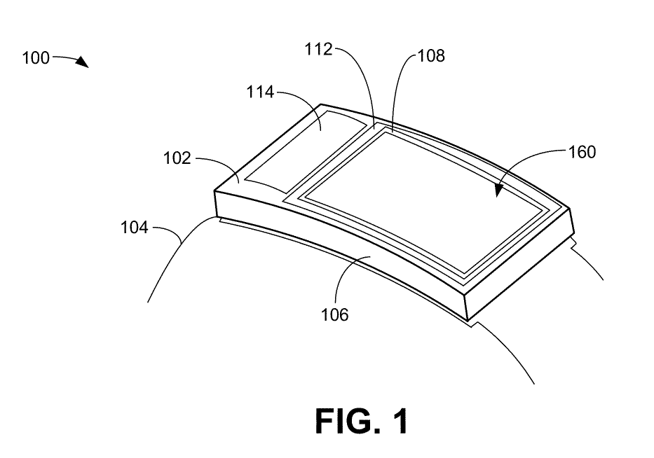

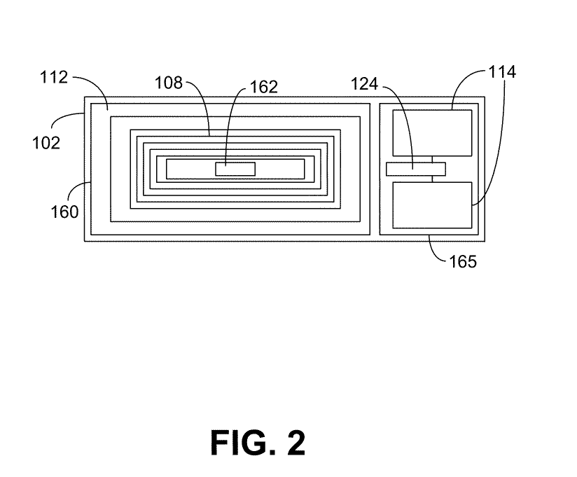

FIG. 1 is a schematic diagram illustrating a high-frequency (HF)/ultra high-frequency (UHF) RFID assembly 100. The HF/UHF RFID assembly 100 is also referred to as the “RFID assembly.” The RFID assembly 100 comprises a HF/UHF RFID module 102, also referred to as the “RFID module,” located on a backplane 104. In an embodiment, the RFID module 102 comprises a high-frequency antenna 108 integrated onto a high-frequency subassembly 160. The RFID module 102 also includes a planar UHF antenna 114 integrated onto a UHF subassembly 165 (FIG. 2). The planar UHF antenna 114 comprises a substrate that can be formed using copper, aluminum, or another conductive material, onto which one or more UHF circuit elements can be formed.

The HF subassembly 160 also includes a ferrite isolator 112 separating and electrically isolating the high-frequency antenna 108 from the planar UHF antenna 114. The RFID module 102 also includes a spacer 106 around which the planar UHF antenna 114 is assembled. The spacer 106 can be any high dielectric material, and, in an embodiment, can be made from polycarbonate, or another suitable material. The spacer 106 can be formed to have a curved structure designed to fit comfortably against the wrist of a wearer when the RFID assembly 100 is molded or otherwise contained within a wearable element, such as a wristband.

FIG. 2 is a plan view illustrating the RFID module 102 of FIG. 1. The HF subassembly 160 is mounted approximately as shown on the top surface of the RFID module 102, adjacent to the UHF IC 124. The HF subassembly 160 comprises the ferrite isolator 112, which isolates the high-frequency antenna 108 from the surface of the planar UHF antenna 114. The RFID module 102 also includes the planar UHF antenna 114 and UHF IC 124, comprising the UHF subassembly 165 formed thereon.

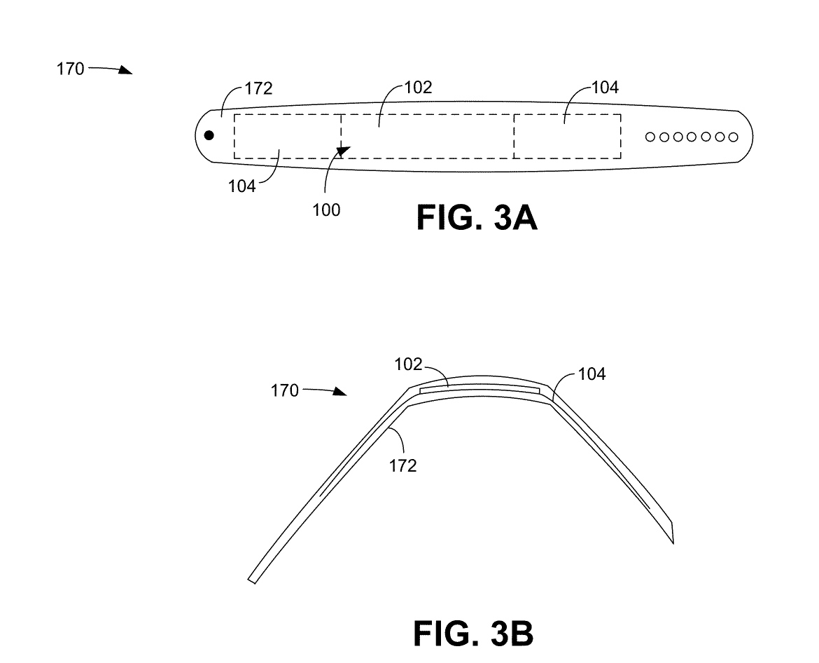

FIG. 3A is a plan view illustrating a wristband assembly 170 having the RFID assembly 100 of FIG. 1. The wristband assembly 170 includes a wristband portion 172 in which the RFID assembly 100 is contained. The RFID assembly 100 can be secured inside the wristband portion 172 by, for example, injection molding, or another fabrication technique. The backplane 104 can comprise a conductive foil, such as aluminum, copper, or another conductive material, and serves as an energy collection element to electrically excite the UHF subassembly 165, and also serves to isolate the UHF subassembly 165 from the human skin, which absorbs the RFID energy.

FIG. 3B is a cross-sectional view illustrating the wristband assembly 170. The wristband assembly 170 includes the RFID module 102 applied over the backplane 104, forming the RFID assembly 100. The RFID assembly 100 is then molded within the wristband 172 to form the wristband assembly 170.

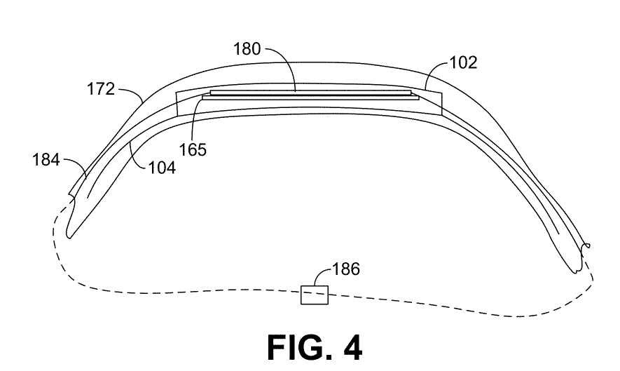

FIG. 4 is a cross-sectional view of a portion of the RFID module 102 located within the wristband 172 of FIG. 3A and FIG. 3B. In the view shown in FIG. 4, the RFID module 102 comprises the UHF subassembly 165 located adjacent to the energy harvesting system 180. The energy harvesting system 180 can comprise and can interface to one or more energy harvesting device technologies that can provide power to the UHF IC 124 and the UHF antenna 114 to improve the sensitivity of the UHF circuitry. In an embodiment in which the energy harvesting system 180 is adapted to receive radio frequency (RF) energy, or energy coupled to the energy harvesting system 180 using magnetic coupling from which a voltage can be generated to power the UHF IC 124, a loop antenna 184 having one or more concentric revolutions can be electrically coupled to the energy harvesting system 180 and located within the wristband 172. The loop antenna 184 can comprise multiple revolutions, or windings, of wire adapted to receive RF or magnetic energy and, in an embodiment, can be joined with a clasp 186, or other joining means to mechanically and electrically connect the multiple windings within the loop antenna 184 to form a continuous loop antenna that can be incorporated into the removable wristband 172.

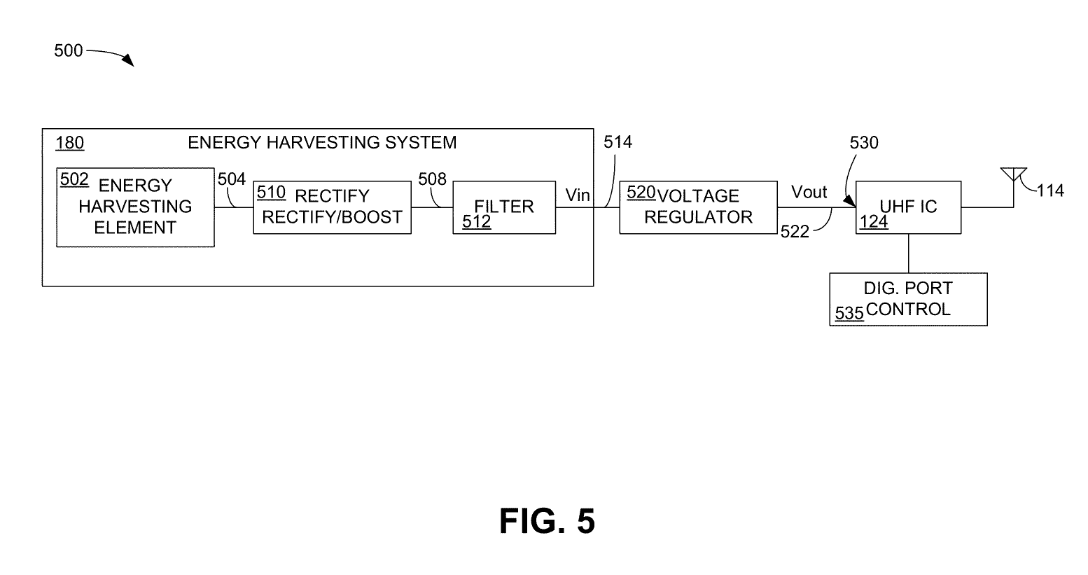

FIG. 5 is a block diagram illustrating a generalized embodiment of the energy harvesting system 180 of FIG. 4, and related circuitry. The energy harvesting system 180 comprises an energy harvesting element 502 adapted to provide a direct current (DC) or alternating current (AC) voltage on connection 504. The power provided by the energy harvesting element 502 can either be provided as a DC voltage, or can be converted to a DC voltage. If the energy harvesting element 502 provides an AC voltage, an optional rectifier, or rectifier and boost element 510 is provided to rectify and convert the AC voltage to a DC voltage before it can ultimately be used to power the UHF IC 124. The rectify and boost element 510 can optionally use diode voltage multiplier techniques to convert the AC voltage to a DC voltage, which can also be used to multiply the AC voltage level by fixed or adjustable increments. A filter/energy storage element 512 receives the signal on connection 508, stores and conditions the energy provided by the energy harvesting element 502 and provides a DC output on connection 514. A non-limiting example of the filter/energy storage element 512 is a capacitor. The signal on connection 514 is referred to as an input voltage, Vin, because it is provided as input to the UHF IC 124.

The voltage on connection 514 is provided to a voltage regulator 520. The voltage regulator 520 stabilizes the input voltage and provides a regulated voltage, Vout, on connection 522. The output voltage on connection 522 is provided to a digitally controlled input/output (I/O) pin 530 on the UHF IC 124. Although not required for operation of the energy harvesting system 180, a digital I/O function, illustrated herein using a digital port control element 535, which switches power input between the energy harvesting system 180 and another supply (not shown) in the UHF IC 124, provides a simple and controllable way of switching to harvested energy for UHF IC 124 and ultimately the UHF antenna 114. In an embodiment, the UHF IC 124 is adapted to operate in a frequency range of approximately 800 MHz to approximately 5.8 GHz. The energy harvesting element 502 can be implemented to passively obtain energy from a variety of sources including, but not limited to, radio frequency (RF), such as AM and FM radio, magnetic coupling of very low frequency (10's of kilohertz (KHz) energy, infrared (IR), visible, solar, ultraviolet, thermal, kinetic, or other sources.

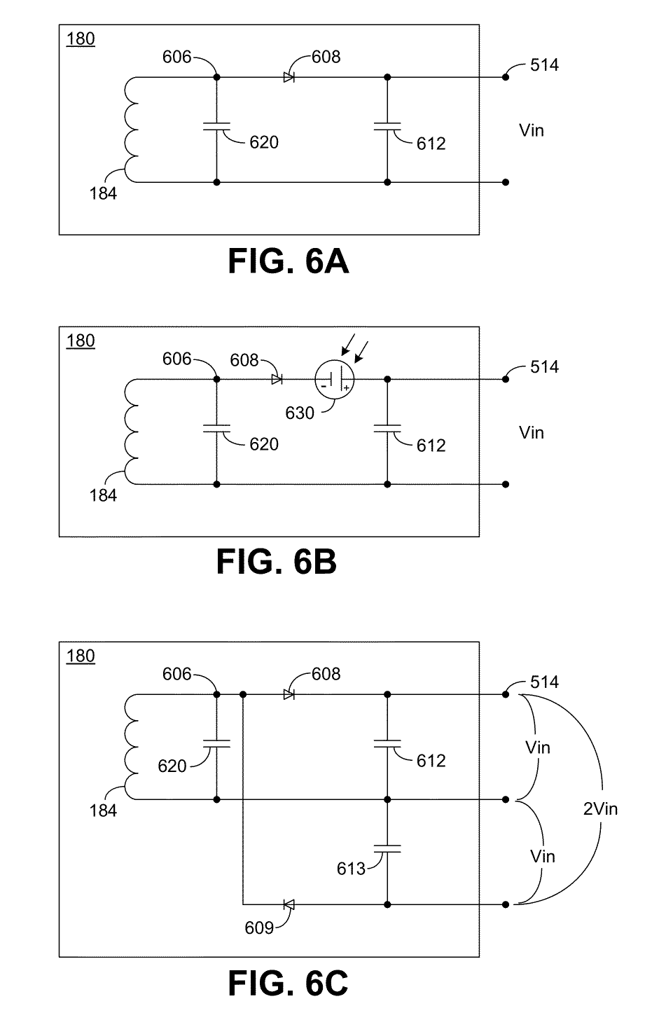

FIG. 6A is a schematic diagram illustrating a first embodiment of the energy harvesting system 180 of FIG. 5. In the embodiment shown in FIG. 6A, the energy harvesting system 180 is adapted to passively harvest energy from radio frequency (RF) energy. One of the challenges when implementing RF energy harvesting technology using circuitry that is in contact with, or in close proximity to human tissue is that human tissue is permeable to RF energy at or below certain frequencies. As known, relatively low-frequency AM and FM radio transmissions easily permeate human tissue. When implemented within a wearable element or object, such as the wristband 172 illustrated in FIGS. 3A and 3B, it would be desirable to have the ability to harvest energy using circuitry located within the wristband 172, at frequencies at which RF energy easily permeates human tissue. Amplitude modulated radio transmissions at a frequency of approximately 1 MHz, and frequency modulated radio transmissions at a frequency of approximately 100 MHz easily permeate human tissue, so radio transmissions at these approximate frequencies are useful for passive energy harvesting when the energy harvesting source is located on or in a wearable object.

The energy harvesting system 180 comprises a loop antenna 184, which can be implemented in a wearable object as described above in FIG. 4. The loop antenna 184 can optionally be resonated by use of a capacitor 620 to increase the available peak AC voltage that can be coupled via connection 606 to a rectifier 608, which is illustrated in this embodiment using a diode, but which can be a synchronous rectifier or any other AC to DC converter. In response to the received RF energy, the energy harvesting system 180 produces the DC output, Vin, at connection 514.

FIG. 6B is a schematic diagram illustrating an alternative embodiment of the energy harvesting system 180 of FIG. 5. Optionally, the available DC voltage Vin on connection 514 can be increased, or boosted, using a supplemental voltage element, also referred to as a boosting element 630. The boosting element 630 is illustrated in FIG. 6B as photocell 630, but can be any other source of DC voltage. The boosting element 630 can provide a small supplemental voltage to forward bias the rectifier 608, thus eliminating a zero voltage output condition that may occur when the output of the loop antenna 184 is insufficient to overcome the approximate 0.3V to 0.6V forward voltage drop of a typical rectifier diode. Because the AC output of the loop antenna 184 is a very low voltage signal, the optional boost element 630 allows Vin to be maintained at an acceptable level even with very low radio frequency input. Other ways to implement the optional boost element 630 include, but are not limited to, a piezoelectric voltage source, a diode with a transparent enclosure that uses ambient light to generate a small voltage, vibration of an electret element, and any another element that can generate a small voltage to forward bias the rectifier 608. A capacitor 612 is used to temporarily condition voltage fluctuations in Vin, and in some cases to bridge gaps in harvested power availability.

FIG. 6C is a schematic diagram illustrating an alternative embodiment of the energy harvesting system 180 of FIG. 5. In cases where a higher DC voltage, Vin, is desired, the AC output 606 of the loop antenna 184 can simultaneously be rectified and multiplied. As is known in the art, a voltage multiplier (in this example a voltage doubler) comprising the diode 608 and the capacitors 620 and 612 of FIG. 6B that form a first AC rectifier and filter, can be combined with an additional diode 609 and an additional capacitor 613 to form a rectifier for the other half cycle of the AC output of the loop antenna 184. In this manner a DC voltage of two times Vin can be derived as opposed to Vin, as shown in FIG. 6B. Optionally, voltage boost elements such as photocell 630 of FIG. 6B can be added in series with each additional diode to offset each additional diodes forward conduction voltage, thus allowing the doubling (or higher level multiplying) circuit to work with AC signals of very low amplitude. The voltage Vin at connection 514 can be provided to the voltage regulator 520, as described above, and ultimately to the UHF IC 124.

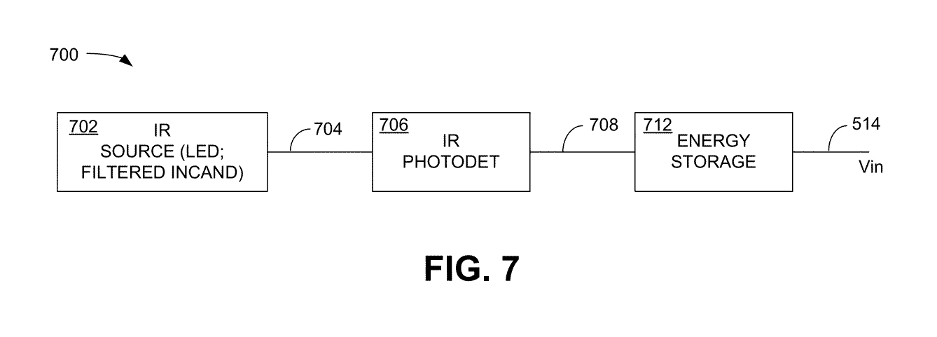

FIG. 7 is a block diagram illustrating another alternate alternative embodiment of the energy harvesting system 180 of FIG. 5. The energy harvesting system 700 can be implemented using an infrared energy source 702. The infrared energy source 702 can be a light emitting diode (LED), or an array of such diodes, configured to emit light at infrared wavelengths, or can be an incandescent light source that is filtered to provide an infrared output, or any other infrared source. The output of the infrared energy source 702 is provided over connection 704 to an infrared photo detector 706. The connection 704 can be air, or another medium through which infrared energy is conducted from the infrared energy source 702 to the infrared photo detector 706. The infrared photo detector 706 provides a DC voltage output on connection 708 that is supplied to an energy storage element 712. The energy storage element 712 may be a capacitor similar to the capacitors 512 and 612 described above.

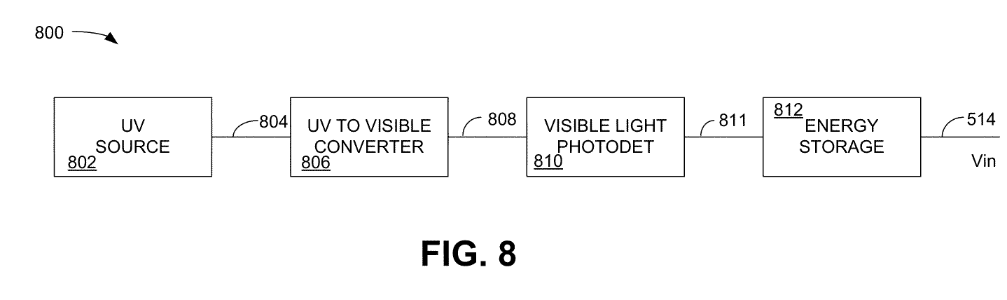

FIG. 8 is a schematic diagram illustrating another alternative embodiment of the energy harvesting system 180 of FIG. 5. The energy harvesting system 800 is implemented using ultraviolet light. An ultraviolet light source 802 provides ultraviolet energy over medium 804 to an ultraviolet-to-visible, or ultraviolet-to-infrared light converter 806. The medium 804 can be air, or any other medium that can conduct ultraviolet light. The light converter 806 (which in one embodiment can be phosphorescent material that glows in the infrared or visible light spectrum when illuminated by ultraviolet light) converts the received ultraviolet energy to visible or infrared light on medium 808. This visible, or infrared light may be more efficiently converted to electrical energy by low cost silicon semiconductors than can the initial ultraviolet light. The medium 808 can be air, or any other medium that can conduct visible or infrared light to a visible or infrared light photo detector 810. The visible or infrared light photo detector 810 receives the visible or infrared light from the ultraviolet-to-visible or ultraviolet-to-infrared light converter 806 and converts the light to a DC voltage signal on connection 811. A DC voltage on connection 811 is provided to an energy storage element 812, which is similar in function operation and structure to the capacitors 512 and 612 described above.

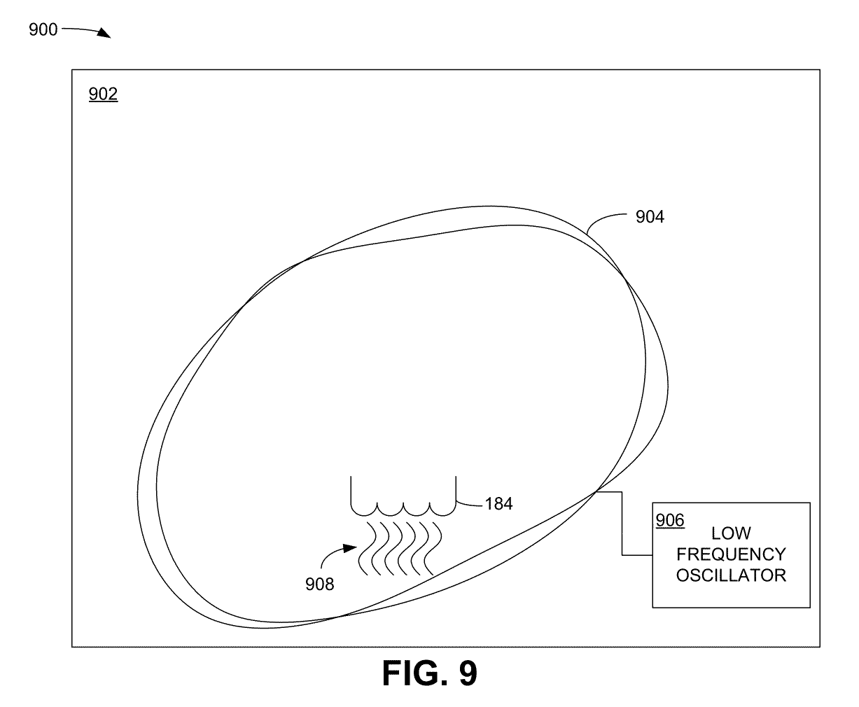

FIG. 9 is a schematic diagram illustrating an example of using low frequency RF energy to create magnetic inductive coupling to supply the energy harvesting element 502. The loop antenna is schematically illustrated using reference numeral 184 as being located in the vicinity of a secondary loop antenna 904. Other elements of the wristband assembly 170 are not shown in FIG. 9 for ease of illustration, but are understood to be included with the loop antenna 184 as described in FIG. 4.

The secondary loop antenna 904 can be a long wound coil of conductive material, such as metallic windings, located within an attraction or area 902. As an example, the attraction or area 902 can be an attraction at an amusement park through which, within which, or in the vicinity of which a wearer of the wristband assembly 170 may pass or enter. A low frequency oscillator 906 can be used to provide a very low frequency signal, such as on the order of tens of KHz, to excite the secondary loop antenna 904 to establish a magnetic field 908 in the vicinity of the attraction or area 902. The magnetic field 908 couples to the loop antenna 184 via inductive coupling so as to provide low frequency magnetic energy to the loop antenna 184 and the energy harvesting system 180. When implemented as shown in FIGS. 6A through 6C, energy can be provided in the form of magnetic inductive coupling, thus generating a DC voltage and current as described above.

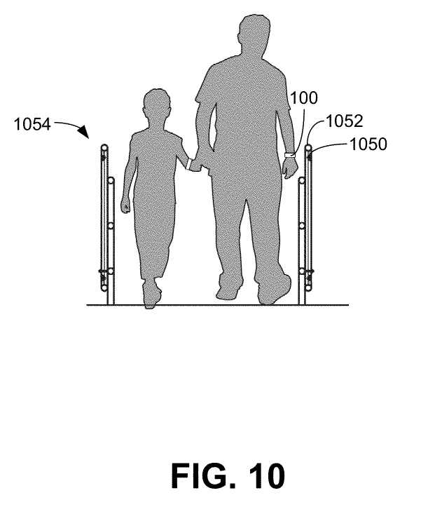

FIG. 10 is a view illustrating an application of the RFID assembly of FIG. 1. As shown in FIG. 10, a magnetic field created by an array of permanent magnets 1050 can also be used to generate an AC voltage by using magnetic field-cutting techniques to couple energy to the loop antenna 184 in the RFID assembly 100. In the example shown in FIG. 10, an array of permanent magnets 1050 mounted along the top rail 1052 of a fence or banister 1054, or any place where it might be expected that a person wearing an RFID assembly 100 might have their hand (and therefore wristband) in close proximity to the magnets, but moving past them, can induce a voltage in loop antenna 184, and be used as harvested power, as described above.

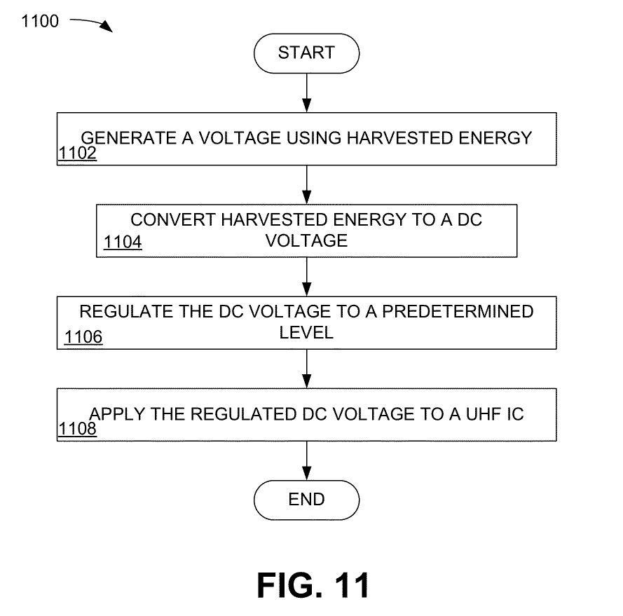

FIG. 11 is a flowchart describing an exemplary method for powering an RFID element using an energy harvesting element.

In block 1102 a voltage is generated by the energy harvesting system 180 (FIG. 5). In block 1104 the harvested energy is converted to a DC voltage as described above.

In block 1106, the DC voltage is regulated to a predetermined level that is usable by the UHF IC 124 (FIG. 5). In block 1108, the regulated DC voltage is applied to the UHF IC 124.

While various embodiments of the invention have been described, it will be apparent to those of ordinary skill in the art that many more embodiments and implementations are possible that are within the scope of the invention.

What is claimed is:

1. A system for powering a radio frequency identification (RFID) module, comprising:
an energy harvesting system configured to passively generate a voltage;
a voltage regulator configured to regulate the passively generated voltage; and
a controllable port through which the passively generated voltage is provided to the RFID module.

2. The system of claim 1, wherein the energy harvesting system further comprises an energy harvesting element configured to passively generate the voltage using energy harvested from a radio frequency (RF) source.

3. The system of claim 1, wherein the energy harvesting system further comprises an energy harvesting element configured to passively generate the voltage using energy harvested from an infrared (IR) source.

4. The system of claim 1, wherein the energy harvesting system further comprises an energy harvesting element configured to passively generate the voltage using energy harvested from an ultraviolet (UV) source.

5. The system of claim 2, further comprising a rectifier configured to rectify the passively generated voltage from an alternating current (AC) to a direct current (DC).

6. The system of claim 5, further comprising a supplemental voltage element configured to provide a supplemental voltage to the rectifier.

7. The system of claim 1, wherein the passively generated voltage is generated by inductive magnetic coupling.

8. The system of claim 1, wherein the system is contained in a wearable item.

9. The system of claim 8, wherein the wearable item is a wristband.

10. The system of claim 9, wherein the wristband comprises a loop antenna coupled to the energy harvesting system.

11. A wearable radio frequency identification (RFID) assembly, comprising:
an RFID module configured to operate over a plurality of frequencies;
an energy harvesting system coupled to the RFID circuitry, the energy harvesting system configured to passively generate an alternating current (AC) voltage;
a rectifier configured to convert the AC voltage to a direct current (DC) voltage;
a voltage regulator configured to regulate DC voltage; and
a controllable port through which the passively generated voltage is provided to the RFID module.

12. The wearable RFID assembly of claim 11, wherein the energy harvesting system further comprises an energy harvesting element configured to passively generate the voltage using energy harvested from a radio frequency (RF) source.

13. The wearable RFID assembly of claim 12, wherein the wearable item is a wristband and the wristband comprises a loop antenna coupled to the RF source.

14. The wearable RFID assembly of claim 13, wherein the RF source comprises a radio broadcast using amplitude modulation (AM) at an approximate frequency of 1 MHz.

15. The wearable RFID assembly of claim 13, wherein the RF source comprises a radio broadcast using frequency modulation (FM) at an approximate frequency of 100 MHz.

16. The wearable RFID assembly of claim 13, further comprising a supplemental voltage element configured to provide a supplemental voltage to the rectifier.

17. A method for powering a radio frequency identification (RFID) module using an energy harvesting element, comprising:
passively generating a voltage using an energy harvesting source;
regulating the passively generated voltage; and
providing the passively generated voltage to the RFID module through a controllable port.

18. The method of claim 17, further comprising passively generating the voltage from a radio frequency (RF) source.

19. The method of claim 17, further comprising passively generating the voltage from an infrared (IR) source.

20. The method of claim 17, further comprising passively generating the voltage from an ultraviolet (UV) source.

21. The method of claim 18, further comprising rectifying the passively generated voltage from an alternating current (AC) to a direct current (DC).

22. The method of claim 21, further comprising generating a supplemental voltage and providing the supplemental voltage to the rectifier to offset an effect of diode forward bias voltage.

23. The method of claim 17, further comprising locating the RFID module and the energy harvesting element in a wearable item.
